(19) United States
(12) Patent Application Publication
(10) Pub. No.: US 2015/0382401 A1
(43) Pub. Date: Dec. 31, 2015

(54) Heated Utensil Kit System

(71) Applicants: Wilfried Dietz, Monterey, CA (US); Claudia Dietz, Monterey, CA (US)

(72) Inventors: Wilfried Dietz, Monterey, CA (US); Claudia Dietz, Monterey, CA (US)

(21) Appl. No.: 14/316,150

(22) Filed: Jun. 26, 2014

(51) Int. Cl. H05B 1/02; H05B 3/06

(52) U.S. Cl. CPC H05B 1/0252; H05B 3/06

(57) ABSTRACT

A heated utensil kit system provides heat to a selectable attachment. The system includes a handle having a first end and a second end. A heat emitter is mounted within an interior of the handle. An adapter is coupled to the first end of the handle. A plurality of attachments is removably engageable with the adapter wherein heat is transferred from the heat emitter to a selectable one of the attachments through the adapter when the selectable one of the attachments is coupled to the adapter. Each of the attachments has an attachment end and a free end. Each of the attachment ends is couplable to the adapter.

### BACKGROUND OF THE DISCLOSURE

### Field of the Disclosure

The disclosure relates to heated utensil kits and more particularly pertains to a new heated utensil kit for providing heat to a selectable attachment.

### SUMMARY OF THE DISCLOSURE

An embodiment of the disclosure meets the needs presented above by generally comprising a handle having a first end and a second end. A heat emitter is mounted within an interior of the handle. An adapter is coupled to the first end of the handle. A plurality of attachments is removably engageable with the adapter wherein heat is transferred from the heat emitter to a selectable one of the attachments through the adapter when the selectable one of the attachments is coupled to the adapter. Each of the attachments has an attachment end and a free end. Each of the attachment ends is couplable to the adapter.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a top front side perspective view of a heated utensil kit system according to an embodiment of the disclosure.

FIG. 2 is a bottom view of an embodiment of the disclosure.

FIG. 3 is a front view of an embodiment of the disclosure.

FIG. 4 is an exploded side view of an embodiment of the disclosure.

FIG. 5 is a side view of a plurality of attachments of an embodiment of the disclosure.

### DESCRIPTION OF THE PREFERRED EMBODIMENT

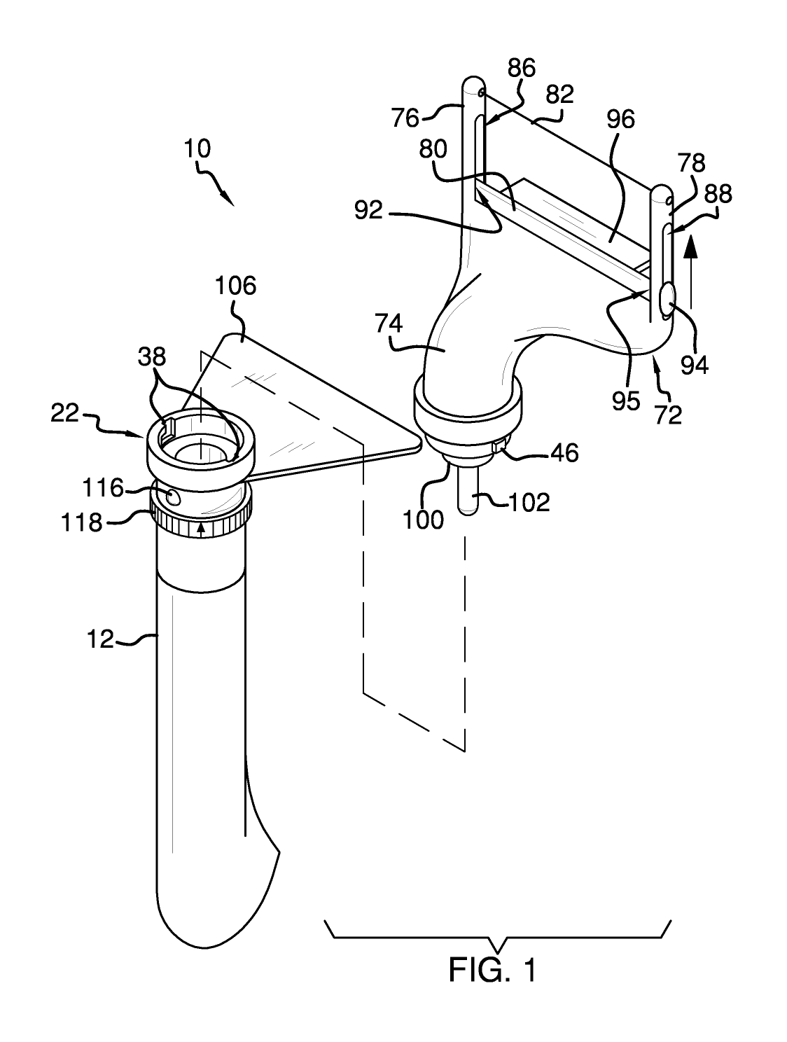

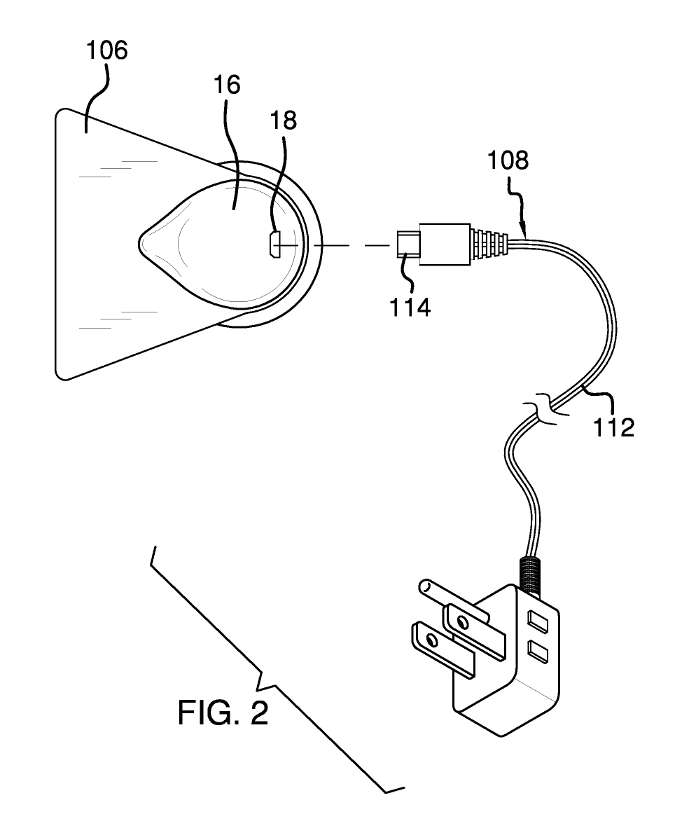

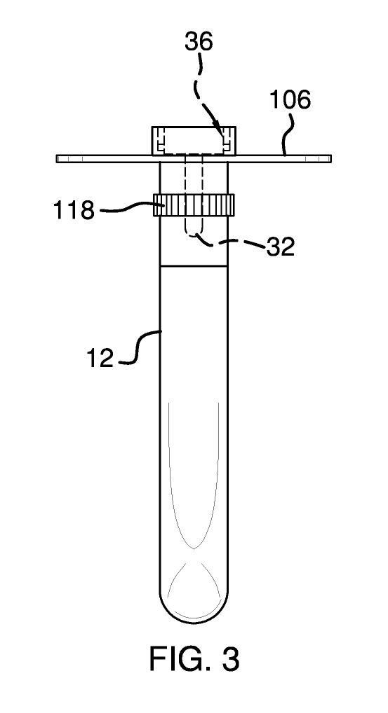

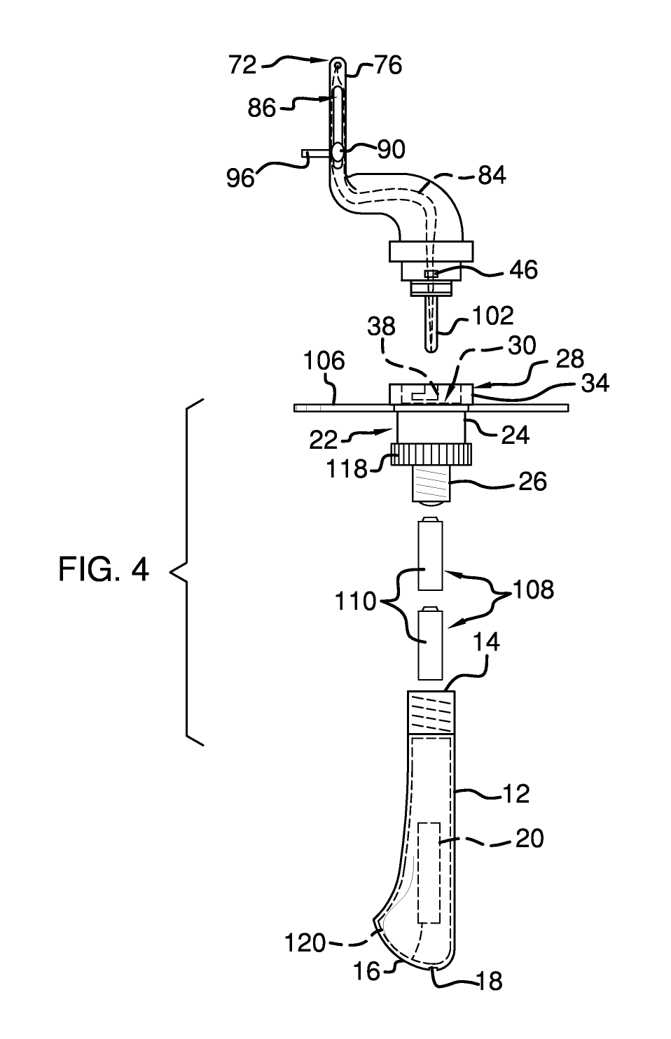

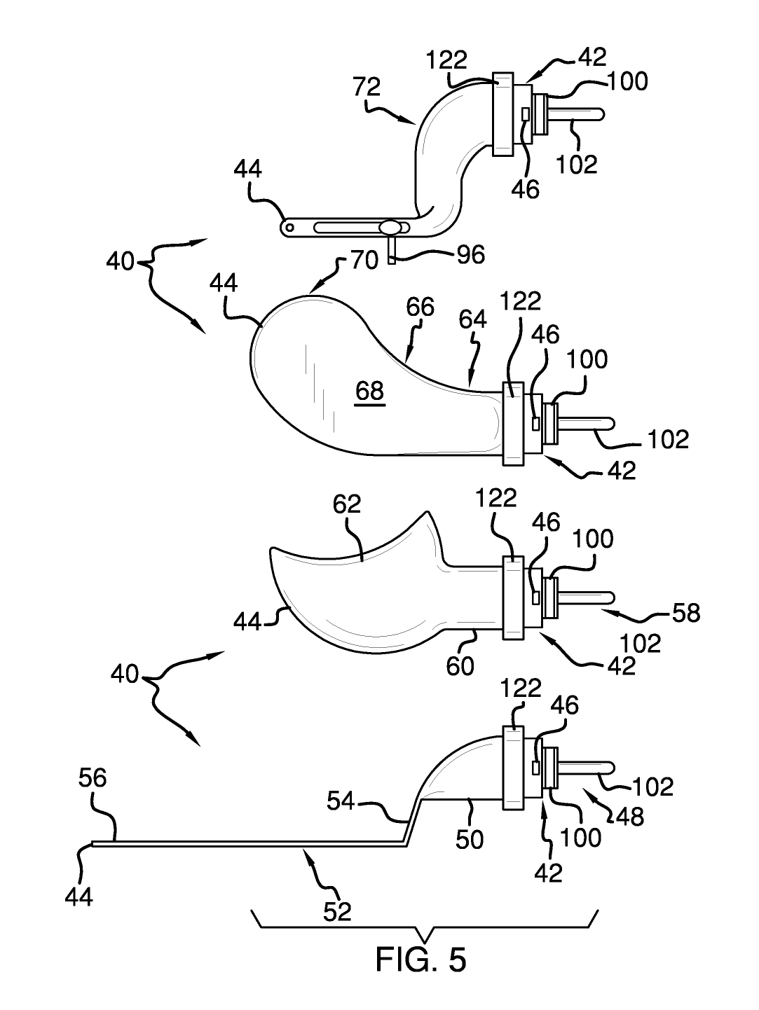

With reference now to the drawings, and in particular to FIGS. 1 through 5 thereof, a new heated utensil kit embodying the principles and concepts of an embodiment of the disclosure and generally designated by the reference numeral 10 will be described.

As best illustrated in FIGS. 1 through 5, the heated utensil kit system 10 generally comprises a handle 12 having a first end 14 and a second end 16. The handle 12 may have a port 18 extending therein. The first end 14 of the handle 12 may be threaded. A heat emitter 20 is mounted within an interior of the handle 12. The handle 12 may be constructed from a rigid material, such as metal or a thermally-insulated plastic material.

An adapter 22 is removably coupled to the first end 14 of the handle 12. The adapter 22 includes a main body 24 and a threaded tube 26 attached together. The threaded tube 26 engages the first end 14 of the handle 12 for threadably coupling the adapter 22 to the first end 14 of the handle 12. A top section 28 of the adapter 22 has an opening 30 positioned therein. A female receiver 32 is positioned in the opening 30. The top section 28 includes a lip 34 extending around the opening 30. An inner surface 36 of the lip 34 has a plurality of grooves 38 extending therein.

A plurality of attachments 40 is removably engageable with the adapter 22 wherein heat is transferred from the heat emitter 20 to a selectable one of the attachments 40 through the adapter 22 when the selectable one of the attachments 40 is coupled to the adapter 22. Each of the attachments 40 has an attachment end 42 and a free end 44. Each of the attachment ends 42 is couplable to the adapter 22. Each attachment 40 has a plurality of tabs 46 coupled thereto positioned proximate the attachment end 42 of the associated attachment 40. The tabs 46 of each attachment 40 are engageable with the grooves 38 for securing the selectable one of the attachments 40 to the adapter 22. Each of the attachments 40 may have a respective collar 122 attached thereto and positioned proximate the attachment end 42 of the associated attachment 40. Each collar 122 abuts the lip 34 when the selectable one of the attachments 40 is attached to the adapter 22.

The plurality of attachments 40 may include a spatula attachment 48 having a base 50 and a spatula blade 52 coupled together. The base 50 is positioned between the spatula blade 52 and the adapter 22 when the spatula attachment 48 is coupled to the adapter 22. The spatula blade 52 may include an angled section 54 and a planar section 56. The angled section 54 is attached to and extends between the planar section 56 and the base 50 to laterally offset the spatula blade 52 from the base 50. Shortening, butter-based frosting or the like is positioned on the spatula blade 52 and is applied to a desired food item in a conventional manner. However, the heat emitter 20 warms the spreadable food item or like material to make the material more spreadable. The spatula blade 52 is comprised of a rigid material, such as metal, plastic or the like. A scoop attachment 58 may also be provided. The scoop attachment 58 includes a shaft 60 coupled to a scoop member 62. The shaft 60 is positioned between the scoop member 62 and the adapter 22 when the scoop attachment 58 is coupled to the adapter 22. The scoop attachment 58 may resemble that of a conventional ice cream scoop which may be used to heat the scoop member 62 and more easily scoop ice cream with the scoop member 62. The plurality of attachments 40 may also include a spreader attachment 64. The spreader attachment 64 includes a spreader blade 66 having a first surface 68 and a second surface 70 each being planar. The spreader attachment 64 may be used to facilitate the spreading of butter, cold cheese, or a like substance.

The plurality of attachments 40 may further include a slicing attachment 72. The slicing attachment 72 comprises a support 74, a pair of spaced arms 76, 78, a mount 80 and a cutting wire 82. The spaced arms 76, 78 are attached to the support 74 and extend parallel with respect to each other. The arms 76, 78 extend upwardly relative to the support 74. The cutting wire 82 is attached to and extends between the spaced arms 76, 78. The cutting wire 82 is sufficiently taut to provide a suitable cutting element for slicing through cold cheese or like material. The mount 80 is coupled to and extends between each of the arms 76, 78. The mount 80 is spaced below the cutting wire 82. Wiring 84 is positioned in the slicing attachment 72 and extends from the attachment end 42 of the slicing attachment 72 through at least one of the arms 76, 78 to the cutting wire 82 for transferring heat generated from the heat emitter 20 to the cutting wire 82. The slicing attachment 72 is used in a generally conventional manner by using the cutting wire 82 to slice through the cheese while abutting the mount 80 against an outer surface of the cheese to provide a desired cutting thickness. A first one 76 of the arms has a first channel 86 extending longitudinally therethrough. Similarly, a second one 78 of the arms has a second channel 88 extending longitudinally therethrough. A first knob 90 is attached to a first end 92 of the mount 80 and extends outwardly through the first channel 86. A second knob 94 is attached to a second end 95 of the mount 80 and extends outwardly through the second channel 88. The mount 80 is movable within the first 86 and second 88 channels whereby a vertical distance between the cutting wire 82 and the mount 80 is selectively adjustable. This allows the cheese to be cut to a desired thickness. The first 90 and second 94 knobs can be manually grasped to facilitate moving the mount 80 within the first 86 and second 88 channels. An extension 96 is coupled to and extends outwardly from the mount 80 to facilitate gauging a thickness of a slice of the cheese. The extension 96 may be angled slightly downward toward the support 74.

A plurality of connectors 100 is provided. Each of the connectors 100 is attached to an associated one of the attachment ends 42. Each of the connectors 100 has a respective male coupler 102 attached thereto that extends downwardly therefrom. The female receiver 32 receives one of the male couplers 102 when the selectable one of the attachments 40 is coupled to the adapter 22. A guard 106 is coupled to and extends outwardly from the adapter 22 wherein the guard 106 is configured for resting upon an external surface and supporting the selectable one of the attachments 40 above the surface.

A power source 108 is electrically coupled to the heat emitter 20. The power source 108 may comprise at least one rechargeable battery 110. Alternatively, or in addition, the power source 108 may comprise a power cord 112 that electrically couples to an external electrical outlet. The power cord 112 may include a jack 114 for removably coupling the power cord 112 to the handle 12 by inserting the jack 114 into the port 18. An indicator light 116 may be electrically coupled to the heat emitter 20 wherein the indicator light 116 is turned on when the heat emitter 20 is activated. An actuator 118 is electrically coupled to the heat emitter 20. The actuator 118 is actuated to turn the heat emitter 20 on or off and to select a level of heat emitted by the heat emitter 20. This may be controlled by a rheostat in a generally conventional manner. Indicia may be provided to indicate whether the heat emitter 20 is on or off and what level of heat is being emitted by the heat emitter 20. A sensor 120 may be positioned within the handle 12 and may be operationally coupled to the heat emitter 20 for deactivating the heat emitter 20 after a period of non-use of the handle 12.

In use, the adapter 22 is attached to the handle 12, and the desired attachment 40 is coupled to the adapter 22. The attachments 40 are interchangeable and attached and removed as needed. The heat emitter 20 is actuated to produce heat which warms up the attachment 40 that is attached to the adapter 22. The attachment 40 is used in a conventional manner to accomplish its intended purpose. For example, the slicing attachment 72 can be used to slice cheese; the scoop attachment 58 can be used to scoop ice cream; and the spreader attachment 64 can be used to spread butter, frosting or the like. However, the heat emitter 20 heats up the attachment 40 and allows the attachment 40 to function more efficiently, for example, by heating up the cheese to be sliced or the frosting to be spread when the attachment 40 comes into contact with the associated food product.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A heated utensil kit system comprising:
a handle having a first end and a second end;
a heat emitter mounted within an interior of said handle;
an adapter coupled to said first end of said handle; and
a plurality of attachments removably engageable with said adapter wherein heat is transferred from said heat emitter to a selectable one of said attachments through said adapter when said selectable one of said attachments is coupled to said adapter, each of said attachments having an attachment end and a free end, each of said attachment ends being couplable to said adapter.

2. The system of claim 1, further comprising a power source electrically coupled to said heat emitter.

3. The system of claim 2, further comprising wherein said power source comprises at least one rechargeable battery.

4. The system of claim 2, further comprising wherein said power source comprises a power cord electrically coupling to an external electrical outlet.

5. The system of claim 4, further comprising:
said handle having a port extending therein; and
said power cord including a jack for removably coupling said power cord to said handle by inserting said jack into said port.

6. The system of claim 2, further comprising an indicator light electrically coupled to said heat emitter, said indicator light being turned on when said heat emitter is activated.

7. The system of claim 1, further comprising an actuator electrically coupled to said heat emitter, said actuator being actuated to turn said heat emitter on or off and to select a level of heat emitted by said heat emitter.

8. The system of claim 1, further comprising said adapter being removably coupled to said first end of said handle.

9. The system of claim 8, further comprising:
said first end of said handle being threaded; and
said adapter including a main body and a threaded tube attached together, said threaded tube engaging said first end of said handle for threadably coupling said adapter to said first end of said handle.

10. The system of claim 1, further comprising a guard coupled to and extending outwardly from said adapter wherein said guard is configured for resting upon an external surface and supporting said selectable one of said attachments above the surface.

11. The system of claim 1, further comprising:
a plurality of connectors, each of said connectors being attached to an associated one of said attachment ends, each of said connectors having a respective male coupler attached thereto and extending downwardly therefrom;
a top section of said adapter having an opening positioned therein; and
said top section of said adapter including a female receiver positioned in said opening, said female receiver receiving one of said male couplers when said selectable one of said attachments is coupled to said adapter.

12. The system of claim 1, further comprising:
a top section of said adapter having an opening positioned therein;
said top section of said adapter including a lip extending around said opening, an inner surface of said lip having a plurality of grooves extending therein; and
each said attachment having a plurality of tabs coupled thereto positioned proximate said attachment end of said associated attachment, said tabs of each said attachment being engageable with said grooves for securing said selectable one of said attachments to said adapter.

13. The system of claim 1, further comprising a sensor positioned within said handle, said sensor being operationally coupled to said heat emitter for deactivating said heat emitter after a period of non-use of said handle.

14. The system of claim 1, further comprising wherein said plurality of attachments includes a spatula attachment having a base and a spatula blade coupled together, said base being positioned between said spatula blade and said adapter when said spatula attachment is coupled to said adapter, said spatula blade including an angled section and a planar section, said angled section being attached to and extending between said planar section and said base to laterally offset said spatula blade from said base.

15. The system of claim 1, further comprising wherein said plurality of attachments includes a scoop attachment, said scoop attachment including a shaft coupled to a scoop member, said shaft being positioned between said scoop member and said adapter when said scoop attachment is coupled to said adapter.

16. The system of claim 1, further comprising wherein said plurality of attachments includes a spreader attachment, said spreader attachment including a spreader blade having a first surface and a second surface each being planar.

17. The system of claim 1, further comprising:
wherein said plurality of attachments includes a slicing attachment, said slicing attachment including a support, a pair of spaced arms, a mount and a cutting wire, said spaced arms being attached to said support and extending parallel with respect to each other, said arms extending upwardly relative to said support, said cutting wire being attached to and extending between said spaced arms, said mount being coupled to and extending between each of said arms, said mount being spaced below said cutting wire; and
wiring positioned in said slicing attachment and extending from said attachment end of said slicing attachment through at least one of said arms to said cutting wire for transferring heat generated from said heat emitter to said cutting wire.

18. The system of claim 17, further comprising:
a first one of said arms having a first channel extending longitudinally therethrough;
a second one of said arms having a second channel extending longitudinally therethrough;
wherein said mount is movable within said first and second channels whereby a vertical distance between said cutting wire and said mount is selectively adjustable;
a first knob attached to a first end of said mount and extending outwardly through said first channel; and
a second knob attached to a second end of said mount and extending outwardly through said second channel, manual grasping of each of said first and second knobs facilitates moving said mount within said first and second channels.

19. The system of claim 17, further comprising an extension coupled to and extending outwardly from said mount.

20. A heated utensil kit system comprising:
a handle having a first end and a second end, said handle having a port extending therein, said first end of said handle being threaded;
a heat emitter mounted within an interior of said handle;
an adapter removably coupled to said first end of said handle, said adapter including a main body and a threaded tube attached together, said threaded tube engaging said first end of said handle for threadably coupling said adapter to said first end of said handle, a top section of said adapter having an opening positioned therein, a female receiver being positioned in said opening, said top section of said adapter including a lip extending around said opening, an inner surface of said lip having a plurality of grooves extending therein;
a plurality of attachments removably engageable with said adapter wherein heat is transferred from said heat emitter to a selectable one of said attachments through said adapter when said selectable one of said attachments is coupled to said adapter, each of said attachments having an attachment end and a free end, each of said attachment ends being couplable to said adapter, each said attachment having a plurality of tabs coupled thereto positioned proximate said attachment end of said associated attachment, said tabs of each said attachment being engageable with said grooves for securing said selectable one of said attachments to said adapter, said plurality of attachments including;
a spatula attachment having a base and a spatula blade coupled together, said base being positioned between said spatula blade and said adapter when said spatula attachment is coupled to said adapter, said spatula blade including an angled section and a planar section, said angled section being attached to and extending between said planar section and said base to laterally offset said spatula blade from said base;
a scoop attachment, said scoop attachment including a shaft coupled to a scoop member, said shaft being positioned between said scoop member and said adapter when said scoop attachment is coupled to said adapter;
a spreader attachment, said spreader attachment including a spreader blade having a first surface and a second surface each being planar; and
a slicing attachment, said slicing attachment including a support, a pair of spaced arms, a mount and a cutting wire, said spaced arms being attached to said support and extending parallel with respect to each other, said arms extending upwardly relative to said support, said cutting wire being attached to and extending between said spaced arms, said mount being coupled to and extending between each of said arms, said mount being spaced below said cutting wire, wiring positioned in said slicing attachment and extending from said attachment end of said slicing attachment through at least one of said arms to said cutting wire for transferring heat generated from said heat emitter to said cutting wire, a first one of said arms having a first channel extending longitudinally therethrough, a second one of said arms having a second channel extending longitudinally therethrough, a first knob attached to a first end of said mount and extending outwardly through said first channel, a second knob attached to a second end of said mount and extending outwardly through said second channel, said mount being movable within said first and second channels whereby a vertical distance between said cutting wire and said mount is selectively adjustable, wherein manual grasping of said first and second knobs facilitates moving of said mount within said first and second channels, an extension coupled to and extending outwardly from said mount;
a plurality of connectors, each of said connectors being attached to an associated one of said attachment ends, each of said connectors having a respective male coupler attached thereto and extending downwardly therefrom, said female receiver receiving one of said male couplers when said selectable one of said attachments is coupled to said adapter;
a guard coupled to and extending outwardly from said adapter wherein said guard is configured for resting upon an external surface and supporting a selectable one of said attachments above the surface;
a power source electrically coupled to said heat emitter, said power source comprising at least one rechargeable battery, said power source comprising a power cord electrically coupling to an external electrical outlet, said power cord including a jack for removably coupling said power cord to said handle by inserting said jack into said port;
an indicator light electrically coupled to said heat emitter, said indicator light being turned on when said heat emitter is activated;
an actuator electrically coupled to said heat emitter, said actuator being actuated to turn said heat emitter on or off and to select a level of heat emitted by said heat emitter; and
a sensor positioned within said handle, said sensor being operationally coupled to said heat emitter for deactivating said heat emitter after a period of non-use of said handle.
